(19) United States
(12) Patent Application Publication
(10) Pub. No.: US 2023/0087477 A1
(43) Pub. Date: Mar. 23, 2023

(54) APPARATUS AND METHOD FOR SEPARATING VOICE SECTIONS FROM EACH OTHER

(71) Applicant: ELECTRONICS AND TELECOMMUNICATIONS RESEARCH INSTITUTE, Daejeon (KR)

(72) Inventors: Woo Yong CHOI, Daejeon (KR); Jeon Gue PARK, Daejeon (KR)

(73) Assignee: ELECTRONICS AND TELECOMMUNICATIONS RESEARCH INSTITUTE, Daejeon (KR)

(21) Appl. No.: 17/871,838

(22) Filed: Jul. 22, 2022

(30) Foreign Application Priority Data
Sep. 23, 2021 (KR) 10-2021-0125962

(51) Int. Cl. G10L 21/0272; G10L 21/0208; G10L 25/93

(52) U.S. Cl. CPC G10L 21/0272; G10L 21/0208; G10L 25/93

(57) ABSTRACT

The present disclosure relates to an apparatus and method for separating voice sections from each other. Various embodiments are directed to providing an apparatus and method for separating voice sections from each other, which can maximize speaker separation performance for a short voice section by dividing a short voice section having low speaker separation reliability and separating multiple speakers from one another.

### CROSS-REFERENCE TO RELATED APPLICATIONS

This application claims priority to and the benefit of Korean Patent Application No. 10-2021-0125962, filed on Sep. 23, 2021, the disclosures of which are incorporated herein by reference in their entirety.

### BACKGROUND

### 1. Technical Field

The present disclosure relates to an apparatus and method for separating voice sections from each other.

### 2. Related Art

In general, if two speakers, such as in a call center or one-on-one consultation, have a conversation with each other, it is necessary to classify who said what and when. In this case, an object of classifying who said what and when may be achieved through a speaker separation method.

In particular, in the case of an insurance contract, etc., a consultant reads terms, and a customer answers whether the customer agrees to the terms. In this case, whether the customer agrees to the terms is chiefly performed through a very short and simple voice, such as “yes.” It is very important to confirm whether the customer agrees to the terms by accurately recognizing and identifying the very short and simple voice.

However, a current speaker separation technology has relatively high accuracy for a voice having a sufficient length or more, but has a problem in that the accuracy of a short voice having a length of 0.5 second or less is greatly low.

### SUMMARY

Various embodiments are directed to providing an apparatus and method for separating voice sections from each other, which can maximize speaker separation performance for a short voice section by dividing a short voice section having low speaker separation reliability and separating multiple speakers from one another.

In an embodiment, an apparatus for separating voice sections from each other includes a noise removal unit configured to remove background noise within an input signal received from an input device, a voice extraction unit configured to extract a voice section other than a silent section from the input signal from which the background noise has been removed, a feature extraction unit configured to extract voice feature vectors from the voice section from which the silent section has been excluded, a first speaker embedding extraction unit configured to extract a first speaker embedding vector corresponding to a certain length or more among the extracted voice feature vectors, a first clustering unit configured to cluster the extracted first speaker embedding vectors, a reliability measurement unit configured to calculate reliability of the extracted first speaker embedding vector and comparing the calculated reliability with a preset critical value, a second speaker embedding extraction unit configured to extract a second speaker embedding vector corresponding to less than the certain length from a voice sector having reliability calculated by the reliability measurement unit, a second clustering unit configured to replace the extracted second speaker embedding vectors with the previously clustered first speaker embedding vector cluster and cluster the extracted second speaker embedding vectors, and a post-processing unit configured to identify a speech section for each speaker by synchronizing time information of the second speaker embedding vector clustered by the second clustering unit and the voice section and output the speech section for each speaker.

The feature extraction unit extracts the voice feature vectors while moving on a window of the voice section according to a preset method.

The first clustering unit clusters the extracted speaker embedding vectors as at least two clusters.

The first speaker embedding extraction unit extracts, from the voice feature vectors, the first speaker embedding vector corresponding to the preset length or more.

The second speaker embedding extraction unit extracts, from the voice feature vectors, the second speaker embedding vector corresponding to less than the preset length.

The post-processing unit identifies and outputs the speech section for each speaker and secondarily excludes the silent section.

In an embodiment, a method of separating voice sections from each other includes steps of (a) removing, by a noise removal unit, background noise within an input signal received from an input device, (b) extracting, by a voice extraction unit, a voice section other than a silent section from the input signal from which the background noise has been removed, (c) extracting, by a feature extraction unit, voice feature vectors from the voice section from which the silent section has been excluded, (d) extracting, by a first clustering unit, a first speaker embedding vector corresponding to a certain length or more among the extracted voice feature vectors and clustering the extracted first speaker embedding vectors, (e) calculating, by a reliability measurement unit, reliability of the extracted first speaker embedding vector and comparing the calculated reliability with a preset critical value, (f) extracting, by a second clustering unit, a second speaker embedding vector corresponding to less than the certain length from a voice sector having reliability calculated by the reliability measurement unit, replacing the extracted second speaker embedding vectors with the previously clustered first speaker embedding vector cluster, and clustering the extracted second speaker embedding vectors, and (g) identifying, by a post-processing unit, a speech section for each speaker by synchronizing time information of the second speaker embedding vector clustered by the second clustering unit and the voice section and outputting the speech section for each speaker.

The step (c) includes extracting, by the feature extraction unit, the voice feature vectors while moving on a window of the voice section according to a preset method.

The step (d) includes clustering, by the first clustering unit, the extracted speaker embedding vectors as at least two clusters.

The step (d) includes extracting, by the first speaker embedding extraction unit, the first speaker embedding vector corresponding to the preset length or more from the voice feature vectors.

The step (f) includes extracting, by the second speaker embedding extraction unit, the second speaker embedding vector corresponding to less than the preset length from the voice feature vectors.

The step (g) includes identifying and outputting, by the post-processing unit, the speech section for each speaker and secondarily excluding the silent section.

According to the present disclosure, there is an advantage in that speaker separation performance for a short voice section can be maximized by dividing a short voice section having low speaker separation reliability and separating multiple speakers from one another.

In particular, there is an advantage in that improved performance can be achieved in a field in which speakers need to be separated from one another in a short section, such as an insurance contract, by separating speakers in short voice sections from each other while increasing speaker separation performance.

The effects of the present disclosure are not limited to the above-mentioned effects, and other effects which are not mentioned herein will be clearly understood by those skilled in the art from the following descriptions.

### BRIEF DESCRIPTION OF THE DRAWINGS

FIG. 1 is a diagram illustrating a construction of a short voice section separation apparatus 100 in a speaker separation system according to the present disclosure.

FIG. 2 is a diagram illustrating a reliability distribution of speaker embedding vectors clustered as two clusters.

FIG. 3 is a diagram illustrating, in a series of order, a process of separating, by the short voice section separation apparatus 100, speakers in short voice sections from each other in the speaker separation system of FIG. 1.

### DETAILED DESCRIPTION

The aforementioned object, other objects, advantages, and characteristics of the present disclosure and a method for achieving the objects, advantages, and characteristics will be clearly described through the following embodiments with reference to the accompanying drawings.

However, the present disclosure is not limited to the following embodiments, but may be implemented in various shapes different from each other, and the following embodiments are only provided to easily deliver the purposes, configurations, and effects of the present disclosure to those skilled in the art to which the present disclosure pertains. Therefore, the scope of the present disclosure is defined by claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements, steps and/or devices in addition to mentioned elements, steps and/or devices.

The present disclosure relates to an apparatus and method for separating speakers in short voice sections from each other in a speaker separation system, which can maximize speaker separation performance for a short voice section by dividing the short voice section having low speaker separation reliability and separating multiple speakers from one another.

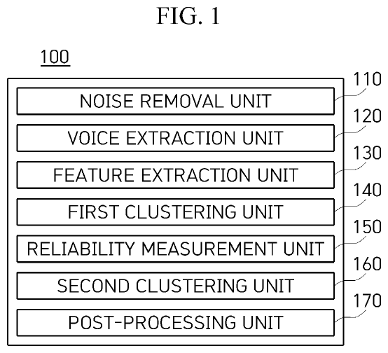

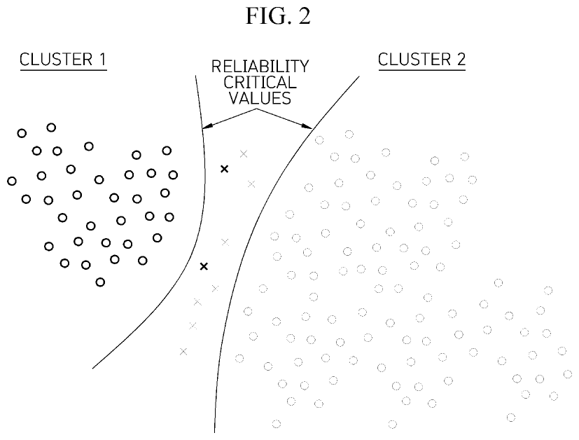

FIG. 1 is a diagram illustrating a construction of a short voice section separation apparatus 100 in a speaker separation system according to the present disclosure. FIG. 2 is a diagram illustrating a reliability distribution of speaker embedding vectors clustered as two clusters.

Referring both to FIGS. 1 and 2, in the speaker separation system according to the present disclosure, the short voice section separation apparatus 100 may be constructed to basically include a noise removal unit 110, a voice extraction unit 120, a feature extraction unit 130, a first clustering unit 140, a reliability measurement unit 150, a second clustering unit 160, and a post-processing unit 170.

The noise removal unit 110 functions to remove background noise or noise from a voice input signal received through a voice input device (e.g., a microphone). The voice extraction unit 120 functions to determine a voice section other than a silent section in a voice input signal from which background noise has been removed by the noise removal unit 110 and to extract only the voice section. In this case, the voice extraction unit 120 determines a corresponding section as a silent section if a voice section is not received for a given time (e.g., 2 seconds or more) within a voice input signal.

The feature extraction unit 130 extracts voice feature vectors from a voice section from which a silent section has been excluded in the entire section of a voice input signal.

Accordingly, the feature extraction unit 130 may identify a speaker by extracting features of a voice input signal for each speaker.

In this case, the feature extraction unit 130 extracts the voice feature vectors while moving on a 25 ms window of a voice section by 10 ms.

The first clustering unit 140 extracts one first speaker embedding vector from voice feature vectors of a long section having a certain length or more (e.g., 2 seconds) among the extracted voice feature vectors. The reliability measurement unit 150 functions to calculate reliability of the extracted first speaker embedding vector, compare the reliability with a preset critical value, and then transmit a result of the comparison to the second clustering unit 160.

In this case, the first clustering unit 140 clusters the extracted first speaker embedding vectors as two clusters. When the reliability of the extracted first speaker embedding vector is smaller than the preset critical value, the reliability measurement unit 150 determines that there is a good possibility that a short voice of another speaker will be included in a corresponding voice feature vector, and transmits such a determination to the second clustering unit 160.

The second clustering unit 160 extracts a second speaker embedding vector (means a finer speaker embedding vector) for a voice section having a certain length or less (e.g., 0.1 second), which is received from the reliability measurement unit 150.

Furthermore, the second clustering unit 160 replaces second speaker embedding vectors corresponding to the certain length or less with the existing cluster, and clusters the second speaker embedding vectors again.

The post-processing unit 170 functions to identify a speech section for each speaker by synchronizing time information of second speaker embedding vectors clustered by the second clustering unit 160 and a voice section from which a silent section has been excluded and to output the speech section for each speaker.

Referring to FIG. 2, two different clusters of speaker embedding vectors clustered by the first clustering unit 140 are disposed on the left and right of FIG. 2. In this case, the two different clusters are classified based on set reliability critical values.

Furthermore, if a speaker embedding vector is disposed between the reliability critical values, the speaker embedding vector means a low speaker embedding vector corresponding to the set reliability critical value or less.

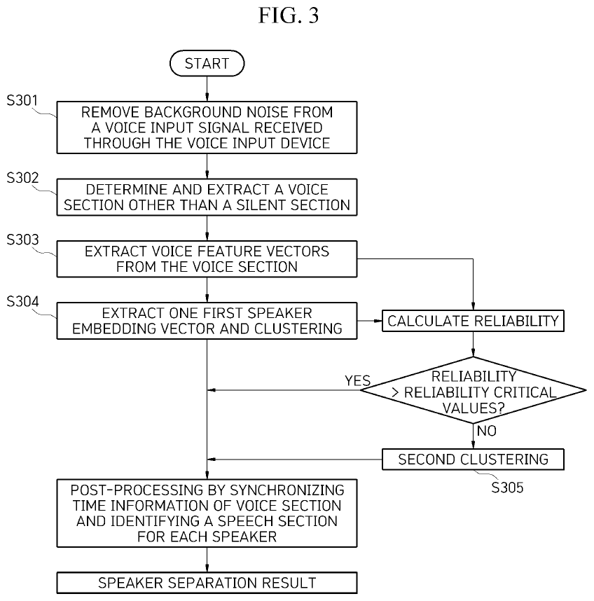

Hereinafter, a process of separating speakers in short voice sections from each other is described with reference to FIG. 3.

FIG. 3 is a diagram illustrating, in a series of order, a process of separating, by the short voice section separation apparatus 100, speakers in short voice sections from each other in the speaker separation system of FIG. 1.

Referring to FIG. 3, first, the noise removal unit 110 removes background noise or noise from a voice input signal received through the voice input device (S301). The voice extraction unit 120 determines only a voice section other than a silent section in the voice input signal from which the background noise has been removed, and extracts the voice section (S302). Next, the feature extraction unit 130 extracts voice feature vectors from the voice section from which the silent section has been excluded in the entire section of the voice input signal (S303). The first clustering unit 140 extracts one first speaker embedding vector from voice feature vectors of a long section having a certain length among the extracted voice feature vectors, and then transmits the first speaker embedding vector to the reliability measurement unit 150 (S304).

The reliability measurement unit 150 determines whether reliability of the extracted first speaker embedding vector is equal to or smaller than a preset critical value. When the reliability of a corresponding first speaker embedding vector is greater than the preset critical value, the reliability measurement unit 150 immediately such a determination to the post-processing unit 170 so that the post-processing unit 170 identifies a speech section for each speaker by synchronizing time information of corresponding first speaker embedding vectors and a voice section from which a silent section has been excluded and then outputs the speech section. When the reliability of the corresponding first speaker embedding vector is equal to or smaller than the preset critical value, the reliability measurement unit 150 determines that there is a good possibility that a short voice of another speaker will be included in a corresponding voice feature vector, and transmits such a determination to the second clustering unit 160 (S305).

In this case, the second clustering unit 160 replaces second speaker embedding vectors corresponding to a certain length or less with the existing cluster, clusters the second speaker embedding vectors again, and transmits the clustered second speaker embedding vectors to the post-processing unit 170. The post-processing unit 170 identifies a speech section for each speaker by synchronizing time information of the corresponding second speaker embedding vectors and a voice section from which a silent section has been excluded, and outputs the speech section for each speaker.

In the speaker separation system according to an embodiment of the disclosure, the method of separating speakers in short voice sections from each other may be implemented in a computer system or may be recorded on a recording medium. The computer system may include at least one processor, a memory, a user input device, a data communication bus, a user output device, and a repository. The aforementioned elements perform data communication through the data communication bus.

The computer system may further include a network interface coupled with a network. The processor may be a central processing unit (CPU) or may be a semiconductor device which processes instructions stored in the memory and/or the repository.

The memory and the repository may include various forms of volatile or non-volatile storage media. For example, the memory may include a ROM and a RAM.

Accordingly, the method of separating speakers in short voice sections from each other in the speaker separation system according to an embodiment of the disclosure may be implemented as a method executable in a computer. In the speaker separation system according to an embodiment of the disclosure, when the method of separating speakers in short voice sections from each other is performed in a computer device, instructions readable by a computer may perform the method of separating speakers in short voice sections from each other in the speaker separation system according to the present disclosure.

The method of separating speakers in short voice sections from each other in the speaker separation system according to the present disclosure may be implemented in a computer-readable recording medium in the form of computer-readable code. The computer-readable recording medium includes all types of recording media in which data interpretable by a computer system has been stored. For example, the computer-readable recording medium may include a read only memory (ROM), a random access memory (RAM), magnetic tapes, magnetic disks, a flash memory, and optical data storages. Furthermore, the computer-readable recording medium may be distributed to computer systems connected over a computer communication network, and may be stored and executed in the form of a code readable in a distributed manner.

What is claimed is:

1. An apparatus for separating voice sections from each other, comprising:
a noise removal unit configured to remove background noise within an input signal received from an input device;
a voice extraction unit configured to extract a voice section other than a silent section from the input signal from which the background noise has been removed;
a feature extraction unit configured to extract voice feature vectors from the voice section from which the silent section has been excluded;
a first speaker embedding extraction unit configured to extract a first speaker embedding vector corresponding to a certain length or more among the extracted voice feature vectors;
a first clustering unit configured to cluster the extracted first speaker embedding vectors;
a reliability measurement unit configured to calculate reliability of the extracted first speaker embedding vector and comparing the calculated reliability with a preset critical value;
a second speaker embedding extraction unit configured to extract a second speaker embedding vector corresponding to less than the certain length from a voice sector having reliability calculated by the reliability measurement unit;
a second clustering unit configured to replace the extracted second speaker embedding vectors with the previously clustered first speaker embedding vector cluster and cluster the extracted second speaker embedding vectors; and
a post-processing unit configured to identify a speech section for each speaker by synchronizing time information of the second speaker embedding vector clustered by the second clustering unit and the voice section and output the speech section for each speaker.

2. The apparatus of claim 1, wherein the feature extraction unit extracts the voice feature vectors while moving on a window of the voice section according to a preset method.

3. The apparatus of claim 1, wherein the first clustering unit clusters the extracted speaker embedding vectors as at least two clusters.

4. The apparatus of claim 1, wherein the first speaker embedding extraction unit extracts, from the voice feature vectors, the first speaker embedding vector corresponding to the preset length or more.

5. The apparatus of claim 1, wherein the second speaker embedding extraction unit extracts, from the voice feature vectors, the second speaker embedding vector corresponding to less than the preset length.

6. The apparatus of claim 1, wherein the post-processing unit identifies and outputs the speech section for each speaker and secondarily excludes the silent section.

7. A method of separating a voice section, comprising steps of:
(a) removing, by a noise removal unit, background noise within an input signal received from an input device;
(b) extracting, by a voice extraction unit, a voice section other than a silent section from the input signal from which the background noise has been removed;
(c) extracting, by a feature extraction unit, voice feature vectors from the voice section from which the silent section has been excluded;
(d) extracting, by a first clustering unit, a first speaker embedding vector corresponding to a certain length or more among the extracted voice feature vectors and clustering the extracted first speaker embedding vectors;
(e) calculating, by a reliability measurement unit, reliability of the extracted first speaker embedding vector and comparing the calculated reliability with a preset critical value;
(f) extracting, by a second clustering unit, a second speaker embedding vector corresponding to less than the certain length from a voice sector having reliability calculated by the reliability measurement unit, replacing the extracted second speaker embedding vectors with the previously clustered first speaker embedding vector cluster, and clustering the extracted second speaker embedding vectors; and
(g) identifying, by a post-processing unit, a speech section for each speaker by synchronizing time information of the second speaker embedding vector clustered by the second clustering unit and the voice section and outputting the speech section for each speaker.

8. The method of claim 7, wherein the step (c) comprises extracting, by the feature extraction unit, the voice feature vectors while moving on a window of the voice section according to a preset method.

9. The method of claim 7, wherein the step (d) comprises clustering, by the first clustering unit, the extracted speaker embedding vectors as at least two clusters.

10. The method of claim 7, wherein the step (d) comprises extracting, by the first speaker embedding extraction unit, the first speaker embedding vector corresponding to the preset length or more from the voice feature vectors.

11. The method of claim 7, wherein the step (f) comprises extracting, by the second speaker embedding extraction unit, the second speaker embedding vector corresponding to less than the preset length from the voice feature vectors.

12. The method of claim 10, wherein the step (g) comprises identifying and outputting, by the post-processing unit, the speech section for each speaker and secondarily excluding the silent section.
